(19) United States
(12) Patent Application Publication
(10) Pub. No.: US 2001/0020204 A1
(43) Pub. Date: Sep. 6, 2001

(54) System for tracking vehicle and driver location and mileage and generating reports therefrom

(76) Inventors: David Runyon, Buford, GA (US); Richard G. Camp, Germantown, TN (US)

Correspondence Address: R. William Graham, 22 S. St. Clair St., Dayton, OH, 45402, US

(21) Appl. No.: 09/796,243

(22) Filed: Feb. 28, 2001

Related U.S. Application Data
(63) Continuation-in-part of application No. 09/519,821, filed on Mar. 6, 2000.

(51) Int. Cl. G06F 7/00; G11B 15/46

(52) U.S. Cl. 701/35; 360/73.01

(57) ABSTRACT

A system for tracking vehicle and driver location, mileage and time and generating reports therefrom is provided. The system includes a device connected to a vehicle which includes a mileage tracking component connected to a central processor having suitable memory associated therewith for receiving and storing an input from the mileage tracking component as input data corresponding to mileage traveled on the vehicle. The device further includes operating software thereon and low power use detector operably connected to a battery on a vehicle for supplying power to said system in one of a normal power use mode and a low power use mode. Also, operably connected to the power supply and the mileage signal generating device is a detector which indicates when the vehicle is in a generally non-mobile state and causing the system to enter into said low power use mode. A SMART card reader/writer device is connected to the central processor and a SMART card having a memory storage thereon is operably associated with the SMART reader/writer device to enable the mileage input data to be written to the memory on the card.

This is a continuation-in-part of U.S. Ser. No. 09/519,821 filed Mar. 6, 2000.

### BACKGROUND OF THE INVENTION

1. Field of the Invention

The invention relates generally to a system for tracking vehicle and driver location and mileage and generating reports therefrom. More particularly, the present invention relates generally to onboard vehicle system for determining location of a vehicle and for monitoring, recording and reporting the mileage driven by a vehicle in a particular state.

2. Related Art

The trucking industry is under guidelines of the Department of Transportation, for safety reasons, and government tax agencies for purposes of levying fuel taxes, which require the management and monitoring of truck mileage and driver time. Often, this mileage and driver time is either inaccurate due to the tracking method or device employed and results in gaps of missing information which can have negative impact on correctly calculating taxes and/or driver time. Accordingly, various systems have been developed to this end.

Some systems employ communication systems directed at automatically obtaining and recording vehicle location and mileage as the truck travels. This information can be used for such purposes as internal dispatching, trip reporting and government reporting.

One current system involves a telecommunications system which transmits a signal via a satellite to a remotely located database. This system includes a global positioning system (GPS) which via the onboard communications transmits its latitudinal and longitudinal coordinates to the remote site via the satellite.

The remote site can then use the particular coordinates to determine the exact location the truck is in, i.e., what town, city, or state in which the truck is traveling. Such coordinates are used to generate the mileage driven in each state, which in turn is used to calculate fuel taxes. Additionally, such coordinates in combination with the transmission times can be of some value in calculating driver time. While this system conceptually is of significant value, the system necessarily involves a telecommunications service provider and monthly fee agreement. This, as will be seen by the present invention, unnecessarily cuts into profits in the trucking industry.

Additionally, there is a need to improve control power management of these systems. The present system provides a user friendly and cost-effective approach to acquiring such information. These and other features and advantages of the present invention will become apparent upon review of the following description taken in conjunction with the accompanying drawings.

### BRIEF SUMMARY OF THE INVENTION

It is an object to improve the way vehicle mileage is tracked, particularly in the trucking industry.

It is another object to employ a relatively inexpensive dual mileage tracking system.

It is a further object to provide a system for tracking vehicle mileage and driver time.

It is yet another object to provide a system for tracking vehicle and driver location, mileage, and time and generating reports therefrom.

Accordingly, the present invention is directed to a system for tracking vehicle and driver location, mileage and time and generating reports therefrom. The system includes a device connected to a vehicle which includes a mileage tracking component connected to a central processor having suitable memory associated therewith for receiving and storing an input from the mileage tracking component as input data corresponding to mileage traveled on the vehicle. The device further includes operating software thereon and low power use detector operably connected to a battery on a vehicle for supplying power to said system in one of a normal power use mode and a low power use mode. Also, operably connected to the power supply and the mileage signal generating device is a detector which indicates when the vehicle is in a generally non-mobile state and causing the system to enter into said low power use mode. Further, the system includes a unit which causes the system to activate to a normal power state from the low power state. A SMART card reader/writer device is connected to the central processor and a SMART card having a memory storage thereon is operably associated with the SMART reader/writer device to enable the mileage input data to be written to the memory on the card.

The mileage tracking component preferably includes a device connected to at least one physical drive component of the vehicle, such as the differential, which corresponds to the mileage vehicle as it operates, and a global positioning signal device which receives position coordinates via a satellite. Still another feature of the invention includes the use of a remote central processing unit (cpu) having a reader/writer device operably associated therewith (via, for example, the Internet) such that data may be exchanged. A further aspect of the invention includes a control power management which is operably associated with the mileage tracking component which monitors the movement of the vehicle and places the system in a low power state until the vehicle is sensed as moving.

Other objects and advantages will be readily apparent to those skilled in the art upon viewing the drawings and reading the detailed description hereafter.

### BRIEF DESCRIPTION OF THE DRAWINGS

FIG. 1 is a front perspective view of a device of the mileage tracking system of the present invention.

FIG. 2 is a rear perspective view of the device of FIG. 1.

FIG. 3 is schematic for the device of FIG. 1.

FIG. 4 is another schematic showing the mileage tracking system of the present invention.

FIG. 5 is still another schematic showing reports generated by the mileage tracking system of the present invention.

FIG. 6 represents a schematic of a power management system of the present invention.

### DETAILED DESCRIPTION OF THE INVENTION

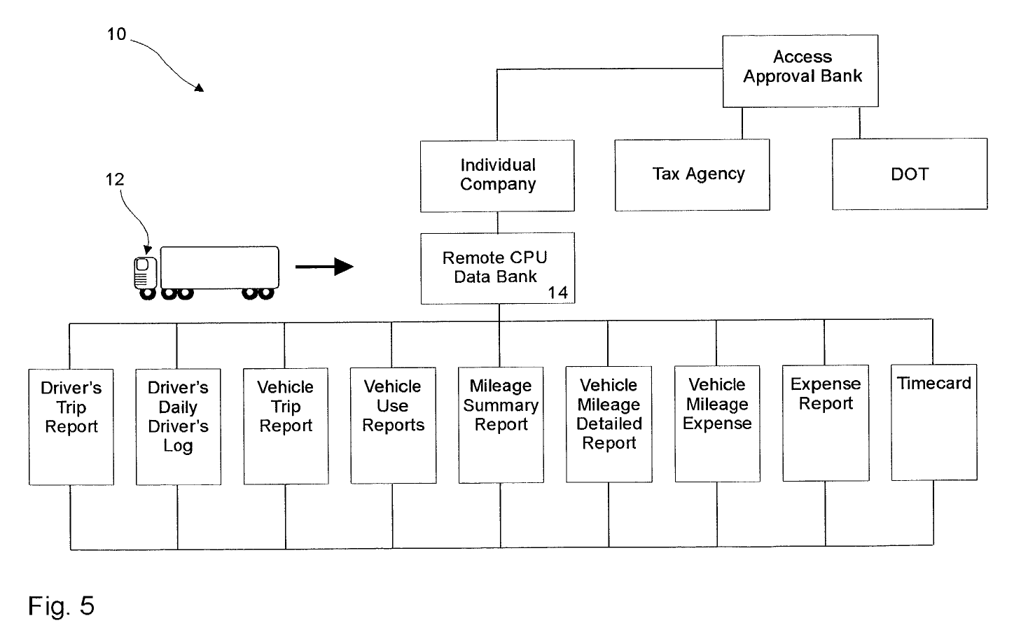

Referring now to the drawings, the mileage tracking system of the present invention is generally denoted by the numeral 10 (FIG. 5). The system 10 includes an onboard device 12 for tracking vehicle mileage, preferably using dual mileage tracking apparatus, and driver time. The system 10 also includes a remotely located cpu 14 having suitable means operably associated with the device 12 for obtaining the tracked mileage and time.

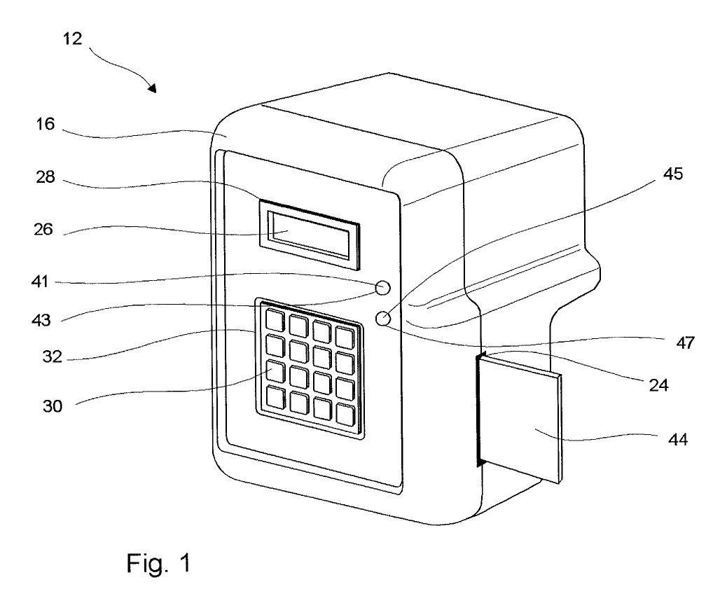

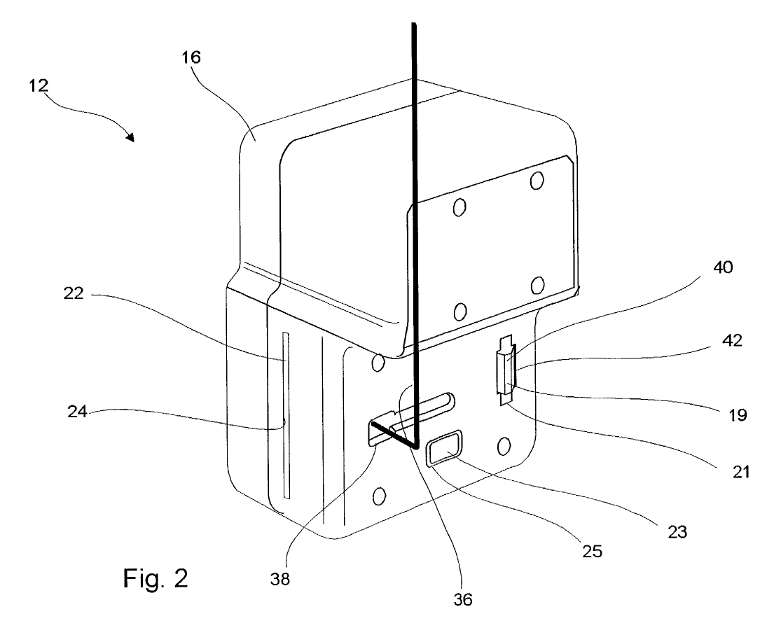

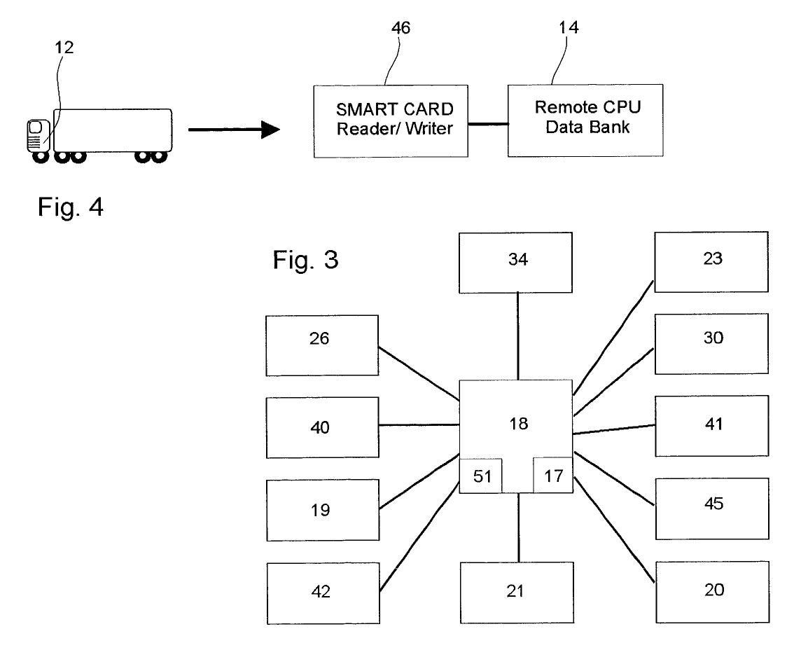

As illustrated in FIGS. 1 and 2, the device 12 includes a housing 16 which is preferably mountable adjacent the driver seat of a vehicle to permit easy access thereto. Inside the housing 16 is a central microprocessor-based computer 18. Further the computer 18 (FIG. 3) has, for example, a board with 386 processor, interface and key display circuitry and includes memory, e.g., ROM DOS and RAM with operating software 17 operably associated therewith and a clock 51. The computer 18 is powered preferably via a DC connector 19 through open surface 21 of housing 16 and is connected to a vehicle power source, such as the battery, with suitable voltage conversion employed.

An R232 serial port 23 is operably connected to the computer 18 to permit rapid transfer of data to and from the computer 18. This may be used when updating operating software, for example. The serial port 23 is disposed in the housing 16 and accessible through port open surface 25 in the housing 16.

Operably connected to the computer 18 is a SMART card reader/writer 20 which is disposed within the housing 16 such that a SMART card receiving port 22 is adjacent a complimentary configured open surface 24 of the housing 16. An LCD display 26 is operably connected to the computer 18 similarly disposed within the housing 16 adjacent an LCD open surface 28 to permit viewing thereof. A keypad 30 is operably connected to the computer 18 similarly disposed within the housing 16 adjacent a keypad open surface 32 to permit actuation thereof.

The computer 18 is operably connected to a global positioning system (GPS) module 34 which is disposed within the housing 16 and in turn connected to an antenna 36 for receiving longitudinal and latitudinal coordinate data (shown here to extend through an antenna open surface 38 of the housing 16) from a satellite (not shown) which provides geographical coordinate location data. The GPS module 34 feeds the coordinate location data to the computer 18.

Also connected to the computer 18 is an odometer input device 40 which includes, for example, a counter operably connected to a moving part of the vehicle, e.g., differential, which feeds an odometer input to the computer 18. Similarly, a speedometer input device 42 can be employed to feed a speedometer input to the computer 18. The odometer input device 40 and speedometer input device 42 connect through open surface 21.

The operating software 17 of the computer 18 can be configured to continuously or at predetermined intervals feed such information to the memory of the computer 18. Preferably, the various input data is fed at predetermined times and/or dates (preferably on an information dependent basis) to conserve resources while still providing useful information to create accurate mileage, time, speed, etc. Further, the operating software 17 permits manual entry of input data information, including, but not limited to, route number, employee number, a service condition of the vehicle, type of service expense costs, start/stop time, etc. Optionally, the operating software can read certain predefined information such as employee number and route number from a SMART card 44. The operating software 17 also includes an ability to read the SMART card 44 for information data, including, but not limited to driver identification and past hours of service information.

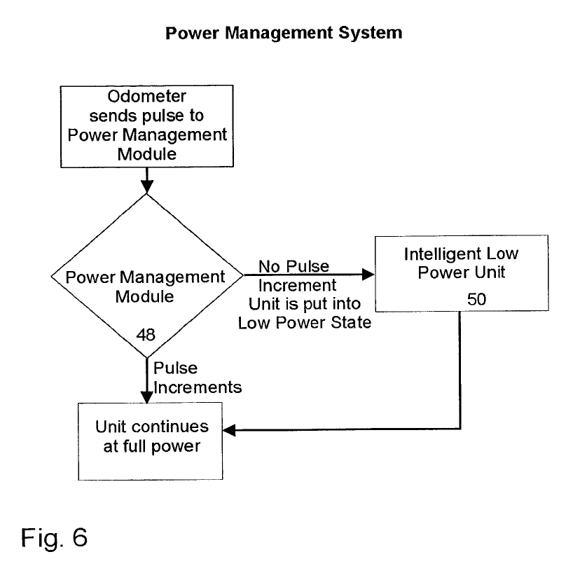

Further, the operating software 17 includes an ability to compute when vehicle mobility is halted for a predetermined time, i.e., a generally non-mobile state. FIG. 6 reflects this aspect of the invention. The lack of mobility can be figured by an odometer pulse count sent to power management module 48, for example, failing to increment for the predetermined time. The operating software 17 senses this and if no pulse increment occurs, the operating software 17 sets the system 10 into a low power state. If the pulse is sensed to increment, the system 10 continues to operate on normal power state.

Once in the low power state, the system 10 is equipped with an intelligent low power unit 50 which monitors the voltage of the odometer cable of the vehicle and upon the voltage crossing a predetermined amount (i.e., senses the vehicle is in a generally mobile state) and awakens the operating software 17 and the restores the system 18 to normal power state. It is further contemplated that power state can be activated manually. For example, the system 10 can change power state upon keypad selection or smartcard insertion/detection.

Power management is a way for the system 10 to draw very little power from the power source(battery) if the vehicle is not moving for some time. This aspect of the invention prevents a drain on the vehicle battery.

Accordingly, the invention further includes a SMART card 44 having a suitable amount of memory thereon to receive and store via the SMART card reader/writer 20 the various input data. The SMART card 44 can then be read by a SMART card reader/writer 46 operably associated with the remotely located cpu 14.

A power LED 41 is operably connected to the computer 18 with an illuminable end exposed through an LED open surface 43 of the housing 16 thus indicating when the device 12 is on. A SMART card LED 45 is operably connected to the computer 18 with an illuminable end exposed through a LED open surface 47 of the housing 16 thus indicating when the SMART card 44 is properly disposed in the reader/writer 46.

The remotely located cpu 14 can be, for example, a Pentium-based server-type or non-server type computer, and includes sufficient memory, e.g., hard disk type, to receive and store input data transferred from a plurality (conceivably thousands) of SMART cards (denoting the information for the drivers and vehicle fleet). It is conceived that the SMART card reader/writer 46 can be directly connected to the cpu 14 or indirectly through a WAN, LAN or Internet connection. Preferably, the cpu 14 includes operating software which is equipped to generate reports relating to a driver's single trip report, driver's daily log, vehicle trip report, vehicle use-condition report (e.g., manually logged service problem), mileage summary report (for tax purposes as discussed), vehicle mileage exception report, expense report, time card report.

Further, the operating software preferably can include third party remote access (preferably on a restricted account/password basis) to said data base to permit remote printing of one or more of said reports on a predetermined basis. The operating software on the cpu 14 can include user predefined characteristics to permit access to particular reports of such user. For example, the Department of Transportation or a tax agency may access remotely the data base and obtain only reports which are required to be reported to such agency whereas the owner of a particular fleet of trucks would have access to all information pertaining to its drivers and fleet.

The operating software in the cpu 14 can manipulate the information using existing projection system to determine location, speed, mileage of the vehicle at a specified times and dates. The means for computing such location, distances and speed are known to the art.

The above described embodiments are set forth by way of example and is not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

What is claimed is:

1. A system for tracking vehicle and driver location, mileage and time and generating reports therefrom, comprising:
mileage signal generating means generating an input signal corresponding to vehicle mileage at least on one of a continuous and predetermined basis;
an onboard central processor having memory, operating software thereon, a clock, a keyboard, means operably connected to a battery on a vehicle for supplying power to said system in one of a normal power use mode and a low power use mode, and display, wherein said central processor is operably connected to said mileage signal generating means for receiving said signal and storing said signal in said memory as mileage input data; and
means operably connected to said power supplying means and said mileage signal generating means for detecting when the vehicle is in a generally non-mobile state and causing said system to enter into said low power use mode.

2. The system for tracking vehicle and driver location, mileage and time and generating reports therefrom of claim 1, which further includes means for detecting when the vehicle is in a generally mobile state and causes said system to enter said normal power use mode.

3. The system for tracking vehicle and driver location, mileage and time and generating reports therefrom of claim 1, wherein said operating software is further characterized to receive data of at least one of driver start and stop time data, vehicle condition data and service data.

4. The system for tracking vehicle and driver location, mileage and time and generating reports therefrom of claim 2, which further includes a first SMART card writer means operably connected to said central processor for enabling writing of said signal to a SMART card, and a SMART card for receivably storing said signal thereon.

5. The system for tracking vehicle and driver location, mileage and time and generating reports therefrom of claim 4, which further includes a remotely located central processor having memory, operating software therein, a clock, a keyboard, power source, and display wherein upon receiving at least one of said data, said operating software includes means for generating selectively generating at least one of a driver's single trip report, driver's daily log, a vehicle trip report, a vehicle use report, mileage summary report, vehicle mileage exception report, expense report, time card report; and
a second remotely located SMART card reader means for enabling reading of said signal stored on said SMART card and transferring said signal to said remotely located central processor.

6. The system for tracking vehicle and driver location, mileage and time and generating reports therefrom of claim 5, wherein said operating software on said remotely located central processor includes means for selectively permitting third party remote access to said data base to permit remote printing of at least one of said reports based upon a predefined user characteristic.

7. The system for tracking vehicle and driver location, mileage and time and generating reports therefrom of claim 1, wherein said mileage generating means includes a mileage counter connectable to a movable part of the vehicle, wherein movement of the part corresponds to mileage of the vehicle and initiates said counter.

8. The system for tracking vehicle and driver location, mileage and time and generating reports therefrom of claim 1, wherein said mileage generating means includes a GPS receiver.

9. The system for tracking vehicle and driver location, mileage and time and generating reports therefrom of claim 8, wherein said mileage generating means further includes a GPS receiver.

10. The system for tracking vehicle and driver location, mileage and time and generating reports therefrom of claim 1, which includes means connected to said onboard central processor for illuminating upon activation of said normal power use mode.

11. The system for tracking vehicle and driver location, mileage and time and generating reports therefrom of claim 4, which includes means connected to said system for illuminating when said SMART card is operably disposed in said SMART card writer of said onboard central processor.

12. The system for tracking vehicle and driver location, mileage and time and generating reports therefrom of claim 4, wherein said SMART card writer of said onboard central processor is further characterized as a SMART card reader/writer.

13. The system for tracking vehicle and driver location, mileage and time and generating reports therefrom of claim 5, wherein said SMART card reader of said remotely located central processor is further characterized as a SMART card reader/writer.

14. The system for tracking vehicle and driver location, mileage and time and generating reports therefrom of claim 1, wherein said onboard central processor is operably connectable to a DC power source of the vehicle.

15. The system for tracking vehicle and driver location, mileage and time and generating reports therefrom of claim 1, which further includes a rapid data transfer port operably connected to said onboard central processor.
